(19) United States
(12) Patent Application Publication
(10) Pub. No.: US 2009/0154478 A1
(43) Pub. Date: Jun. 18, 2009

(54) Scalable Ethernet OAM Connectivity Check in an Access Network

(75) Inventors: Kamakshi Sridhar, Plano, TX (US); Hakki Cankaya, Dallas, TX (US); Gopal Surya, Bangalore (IN); Sven Ooghe, Gentbrugge (BE)

Correspondence Address: Law Office of WILLIAM J. TUCKER, 2631 Lakeforest Ct., Dallas, TX, 75214, US

(73) Assignee: ALCATEL LUCENT, Paris (FR)

(21) Appl. No.: 11/956,316

(22) Filed: Dec. 13, 2007

(51) Int. Cl. H04L 12/56

(52) U.S. Cl. 370/401; 370/400

(57) ABSTRACT

An access node (e.g., Digital Subscriber Line Access Multiplexer) and a method are described herein that proactively monitor the connectivity of one or more end devices (e.g., residential gateways). In one embodiment, the access node performs the following: (a) receives continuity check messages from at least one of the end devices; (b) polls the received continuity check messages to ascertain the connectivity of each end device; and (c) if at least one continuity check message is detected as missing from one of the end devices during the polling step, then an alarm message is sent indicating a loss of connectivity to the one end device. Thereafter, an edge router (e.g., Broadband Network Gateway) would receive the alarm message and know there is no longer a connection to the one end device.

### TECHNICAL FIELD

The present invention relates to an access node (e.g., Digital Subscriber Line Access Multiplexer) and method for proactively monitoring the connectivity of one or more end devices (e.g., residential gateways).

### BACKGROUND

The following abbreviations are herewith defined, at least some of which are referred to in the following description associated with the prior art and the present invention.

### AIS Alarm Indication Signaling

### ANCP Access Node Control Protocol

### BRAS Broadband Remote Access Server

### BNG Broadband Network Gateway

### BTV Broadcast Television

### CC Continuity Check

### CFM Connectivity Fault Management

### DSL Digital Subscriber Line

### DSLAM Digital Subscriber Line Access Multiplexer

### FTTN Fiber to the Node

### FTTU Fiber to the User

### IEEE Institute of Electrical and Electronics Engineers

### IP Internet Protocol

### IPTV Internet Protocol Television

### IWF Interworking Function

### L2CP Layer 2 Control Protocol

### LB Loopback

### LBR Loopback Reply

LT Line Termination (customer-side of a DSLAM)
NT Network Termination (network-side of a DSLAM)

### MA Maintenance Association

### MAC Media Access Control

### MEP Maintenance End Point

### OLT Optical Line Termination

### ONT Optical Network Termination

### PON Passive Optical Network

### RGW Residential Gateway

### SNMP Simple Network Management Protocol

### TV Television

Referring to FIGS. 1-2 (PRIOR ART), there are two block diagrams of a traditional access network 100 with Ethernet-based DSL aggregation (e.g., see DSL Forum TR-101). The traditional access network 100 (e.g., IPTV network 100) includes a regional network 102 which is coupled to an edge router 104 (e.g., BNG 104 with ports 105) which is coupled to one or more aggregation nodes 106 (with ports 106a and 106b). The aggregation node(s) 106 are connected by an Ethernet access network 108 to multiple access nodes 110 (e.g., DSLAMs 110 each of which include a bridge-on-network-interface card 113 which has exterior-facing ports 113a and interior-facing ports 113b and a bridge-on-line card 115 which has interior-facing ports 115a and exterior facing ports 115b). The DSLAMs 110 are connected to multiple RGWs 112 (CPEs 112) which in turn are associated with multiple customers 114 where there is normally one customer 114 associated with one RGW 112. In one application, the BNG 104 transmits BTV traffic 118 (multiple TV channels 118) at the Ethernet level (level 2) downstream via the aggregation node(s) 106, the Ethernet access network 108, the DSLAMs 110, and the RGWs 112 to the customers 114. The basic architecture and functionality of the traditional access network 100 is well known to those skilled in the art but for additional details about this type of architecture reference is made to DSL Forum TR-101 Ethernet-based DSL aggregation dated April 2006 (the contents of which are hereby incorporated by reference herein).

In this broadband access network 100, a provider wants to know if anyone of the RGWs 112 is unreachable before one of the customers 114 calls in with a complaint. Thus, the BNG 104 proactively monitors the connectivity to all of the RGWs 112 so that disconnection problems can be detected before the provider receives a call from a customer 114. This proactive connectivity monitoring is achieved through the use of continuity check (CC) messages which are defined in the IEEE 802.1ag standard entitled “Virtual Bridged Local Area Networks-Amendment 5: Connectivity Fault Management” Feb. 8, 2007 (the contents of which are incorporated by reference herein). Basically, the BNG 104 proactively monitors the connectivity to each of the RGWs 112 by having CC messages 126 flowing on a MA 128 between each of the RGWs 112 and the BNG 104. However, in many applications like the IPTV application there can be a few thousand RGWs 112 connected to a single BNG 104. Thus, the BNG 104 has to process and store the corresponding state information for each of the CC messages 126 that are received from all of the RGWs 112. This scheme causes memory and processing scalability problems at the BNG 104. Accordingly, there has been a need and still is a need for addressing this shortcoming and other shortcomings which are associated with the traditional access network 100. This need and other needs are satisfied by the present invention.

### SUMMARY

In one aspect, the present invention provides a method that could be implemented by an access node (e.g., DSLAM, ONT) to proactively monitor the connectivity of a plurality of end devices (e.g., RGWs, CPEs). The method comprises the steps of: (a) receiving continuity check messages from at least one of the plurality of end devices; (b) polling the received continuity check messages to ascertain the connectivity of each end device; and (c) if at least one continuity check message is detected as missing from one of the end devices during the polling step, then sending an alarm message indicating a loss of connectivity to the one end device. Thereafter, an edge router (e.g., BNG) would receive the alarm message and know there is no longer a connection to the one end device.

In another aspect, the present invention provides an access node (e.g., DSLAM, ONT) with a processor that retrieves instructions from a memory and processes those instructions to enable an interworking function to perform the following operations: (a) receive continuity check messages from at least one of the plurality of end devices (e.g., RGWs, CPEs); (b) poll the received continuity check messages to ascertain the connectivity of each end device; and (c) if at least one continuity check message is detected as missing from one of the end devices during the polling step, then sending an alarm message indicating a loss of connectivity to the one end device. Thereafter, an edge router (e.g., BNG) would receive the alarm message and know there is no longer a connection to the one end device.

In yet another aspect, the present invention provides a method for proactively monitoring the connectivity of a plurality of end devices within an access system which also includes an edge router and an access node. The method comprising the steps of: (a) receiving continuity check messages at the access node, where the continuity check messages are sent from at least one of the plurality of end devices; (b) polling the received continuity check messages at the access node to ascertain the connectivity of each end device; and (c) if at least one continuity check message is detected as missing from one of the end devices during the polling step, then sending an alarm message from the access node to the edge router, where the alarm message indicates a loss of connectivity to the one end device.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIGS. 1-2 (PRIOR ART) are two diagrams of a traditional access network (e.g., IPTV network) which are used to help explain several problems that are solved by the present invention;

FIGS. 3-4 are two diagrams of an access network (with an Ethernet-based DSL aggregation) which has access nodes (e.g., DSLAMs) that implement a method for proactively monitoring the connectivity of end devices (e.g., RGWs, CPEs) in accordance with the present invention;

FIG. 5 is a flowchart illustrating the basic steps of the method for proactively monitoring the connectivity of end devices (e.g., RGWs, CPEs) in accordance with the present invention;

FIG. 6 is a diagram of an exemplary access network which is used to help explain how the proactive monitoring method can be implemented in accordance with one embodiment of the present invention; and

FIG. 7 is a diagram which illustrates the CFM header of an exemplary Ethernet AIS that was configured to be an alarm message which is discussed with respect to the access network shown in FIG. 6 in accordance with the present invention.

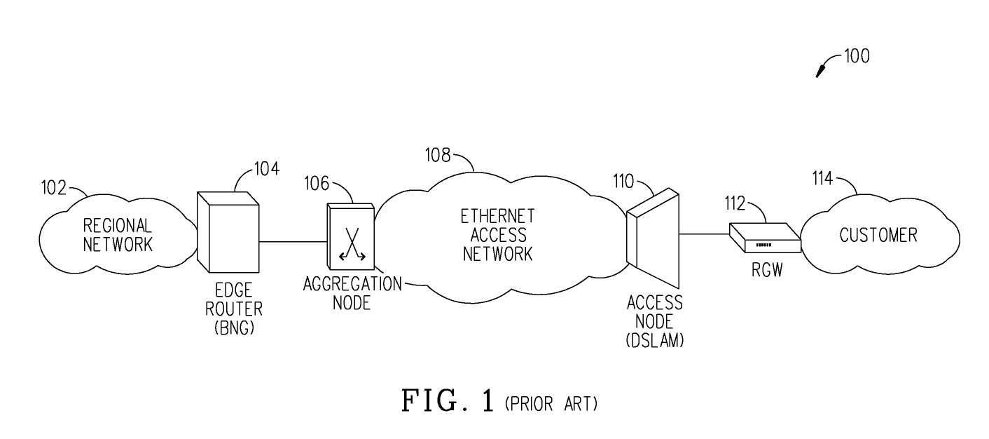

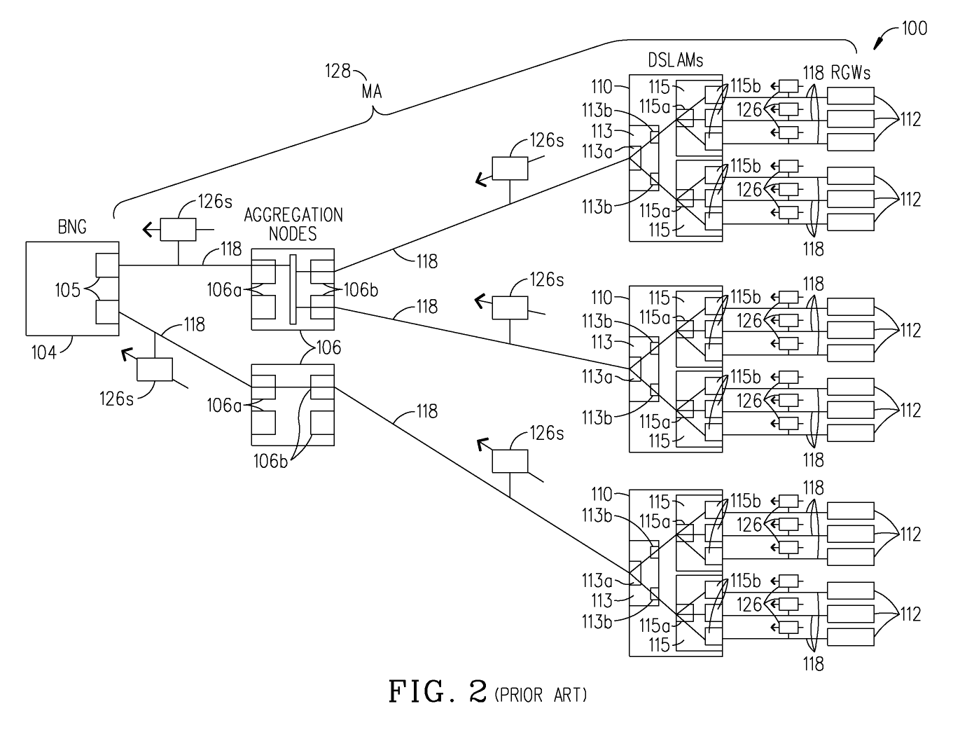

### DETAILED DESCRIPTION

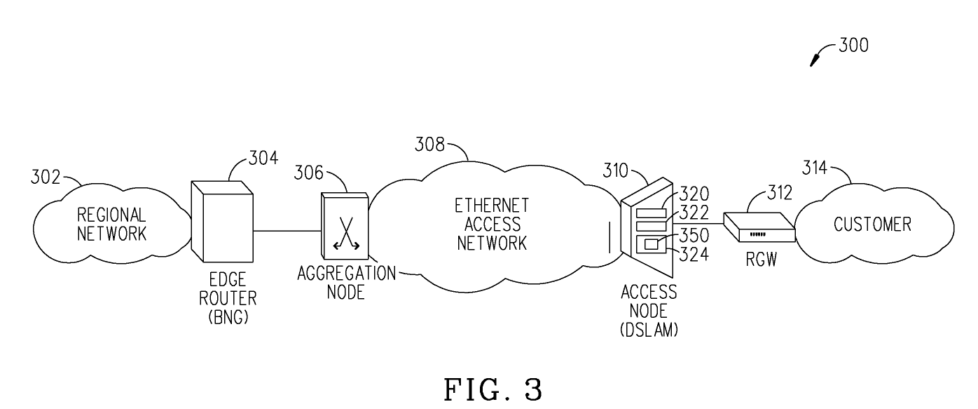

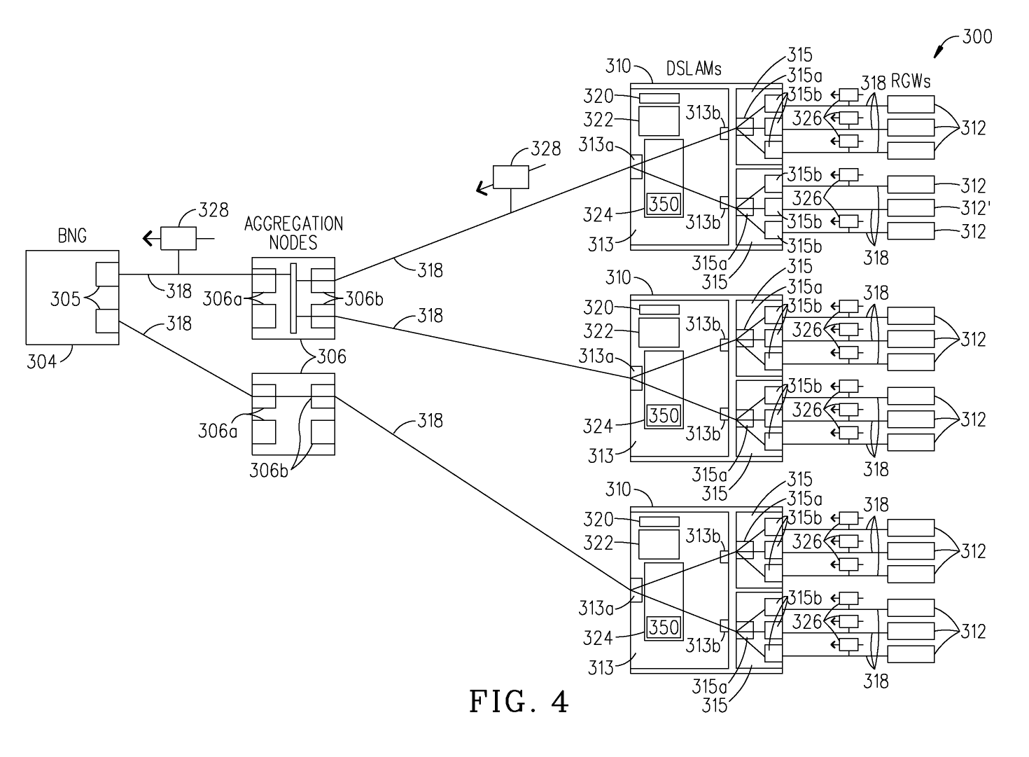

Referring to FIGS. 3-4, there are two block diagrams of an access network 300 (with an Ethernet-based DSL aggregation) which has access nodes 310 (e.g., DSLAMs 310) that implement a method 350 for proactively monitoring the connectivity of end devices 312 (e.g., RGWs 312, CPEs 312) in accordance with the present invention. The access network 300 (e.g., IPTV network 300) includes a regional network 302 which is coupled to an edge router 304 (e.g., BNG 304 with ports 305) which is coupled to one or more aggregation nodes 306 (with ports 306a and 306b). The aggregation node(s) 306 are connected by an Ethernet access network 308 to multiple access nodes 310 (e.g., DSLAMs 310 each of which include a bridge-on-network-interface card 313 which has exterior-facing ports 313a and interior-facing ports 313b and a bridge-on-line card 315 which has interior-facing ports 315a and exterior facing ports 315b). The DSLAMs 310 are connected to multiple RGWs 312 (CPEs 312) which in turn are associated with multiple customers 314 where there is normally one customer 314 associated with one RGW 312. In one application, the BNG 304 transmits BTV traffic 318 (multiple TV channels 318) at the Ethernet level (level 2) downstream via the aggregation node(s) 306, the Ethernet access network 308, the DSLAMs 310, and the RGWs 312 to the customers 314.

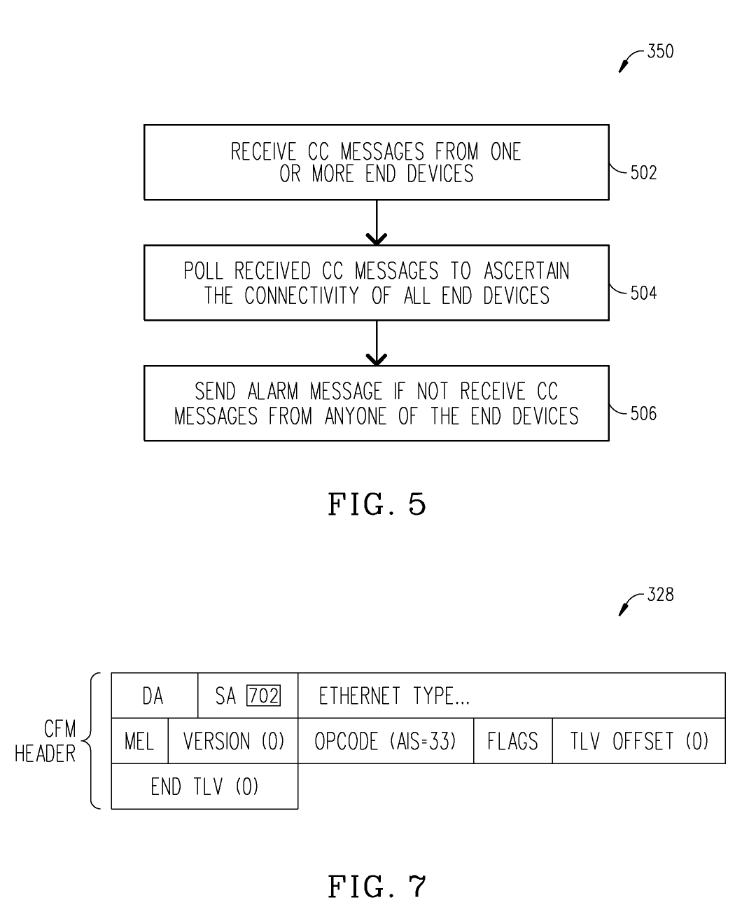

Each DSLAM 310 is shown to have a processor 320 that retrieves instructions from a memory 322 and processes those instructions to enable an interworking function 324 to implement a proactive connectivity monitoring method 350 (see flowchart in FIG. 5) in accordance with the present invention. In one embodiment, each DSLAM 310 and in particular their interworking function 324 implements method 350 to proactively monitor the connectivity of their corresponding end devices 312 (e.g., RGWs 312, CPEs 312) by receiving CC messages 326 from one or more of the corresponding end devices 312 (see step 502). In this example, assume all of the corresponding end devices 312 are sending the CC messages 326 except for one end device 312′. Then, each DSLAM 310 and in particular their interworking function 324 polls the received CC messages 326 to ascertain the connectivity of all of their corresponding end devices 312 (see step 504). If at least one CC message 326 is detected as missing from one of the end devices 312 during the polling step, then the respective DSLAM 310 and in particular their interworking function 324 sends an alarm message 328 to the BNG 304 where the alarm message 328 indicates a loss of connectivity to the one end device 312′ (see step 506).

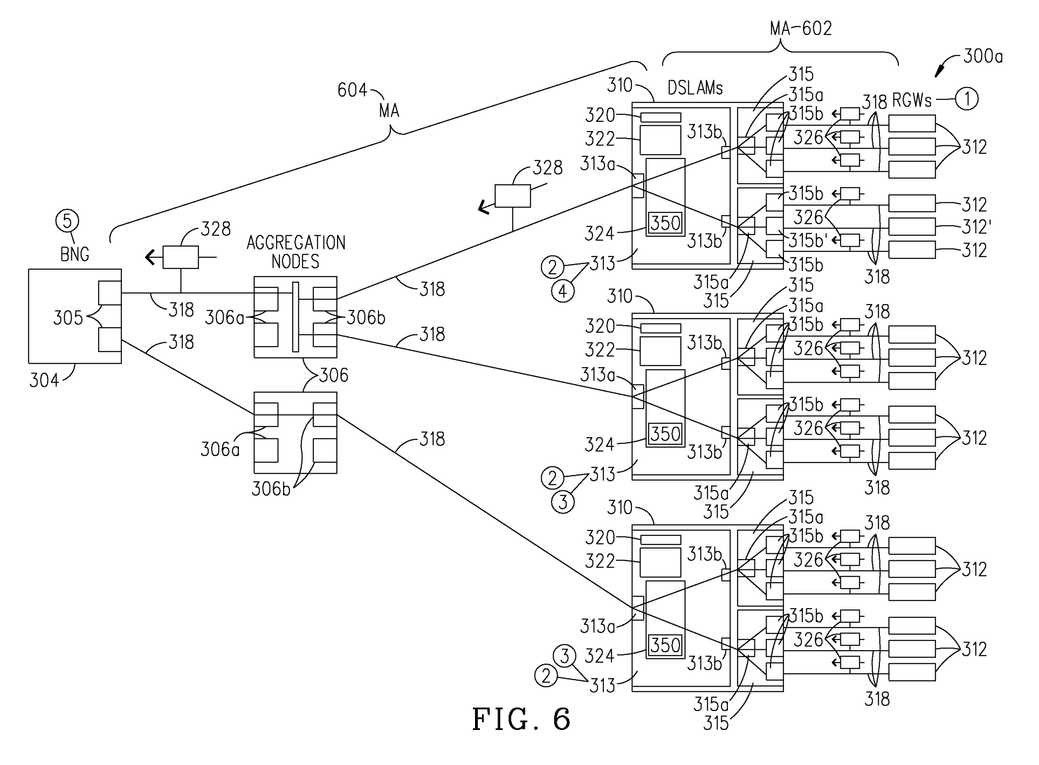

Referring to FIG. 6, there is a block diagram of an exemplary access network 300a which is used to help explain how the proactive connectivity monitoring method 350 can be implemented in accordance with one embodiment of the present invention. The steps of how this particular embodiment of the proactive connectivity monitoring method 350 can be implemented are as follows:

1. The RGWs 312 send periodic CC messages 326 over an access link MA 602 to their corresponding bridge-on-network-interface cards 313 in the DSLAMs 310. The CC message 326 is described in the IEEE 802.1 ag/D8 standard entitled “Virtual Bridged Local Area Networks-Amendment 5: Connectivity Fault Management” Feb. 8, 2007 (the contents of which are hereby incorporated by reference herein).

2. Each bridge-on-network-interface card 313 polls the received CC messages 326 to ensure the reception of at least one CC message 326 from all of the corresponding RGWs 312 (see steps 502 and 504). In one embodiment, the polling is achieved by the IWF 324 that polls the respective access link MA 602 between the corresponding bridge-on-network-interface card 313 and each of the corresponding RGWs 312. How the IWF 324 performs the polling operation is application specific and would depend on the total number of corresponding RGWs 312. In one case, the IWF 324 may have a polling rate=1/n (rate of CC messages 326 coming in) where n=number of user facing ports 315b.

3. If the required number of CC messages 326 from each of the corresponding RGWs 312 are received at the bridge-on-network-interface card 313, then the IWF 324 will do nothing and will not send any alarm message 328 to the BNG 304.

4. If the required CC messages 326 from any of the corresponding RGWs 312 are not received at the bridge-on-network-interface card 313, then the IWF 324 will send an alarm message 328 on an intra carrier MA 604 to the BNG 304 (see step 506)(note: the DSLAM 310 will not expect a response back from the BNG 304). In this example, assume the IWF 324 sends the alarm message 328 after three consecutive CC messages 326 fail to be received from the corresponding RGW 312′. The alarm message 328 identifies the particular RGW 312′ that failed to send the required number of CC messages 326. If there are multiple non-connected RGWs 312′, then the IWF 324 would send multiple alarm signals 328 to the BNG 304. Typically, the alarm message 328 would contain the MAC address or the RGW port ID 315b′ that is associated with the non-connected RGW 312′. If desired, the alarm message 328 could be an Ethernet AIS (which would identify the MAC address of the non-connected RGW 312′), an ANCP/L2CP message (which would identify the MAC address of the non-connected RGW 312′) or a SNMP trap (which would identify the RGW port ID 315b′ of the non-connected RGW 312′). FIG. 7 is a diagram which illustrates the basic CFM header of an exemplary Ethernet AIS 328 configured to be an alarm message 328 which has a SA with an identifier 702 (e.g., MAC address) that is used to identify the non-connected RGW 312′.

5. The BNG 304 upon receiving the alarm message 328 knows that connectivity was lost to the identified non-connected RGW 312′. As can be seen, this method 350 enables scalability processing because the bridge-on-network-interface cards 313 send an alarm message 328 to the BNG 304 only when there happens to be a non-connected RGW 312′. Plus, the bridge-on-network-interface cards 313 send an alarm message 328 as soon as they detect the loss of a certain number of CC message(s) 326 from anyone of their corresponding RGWs 312. Thus, there is no need for the BNG 304 to continuously monitor the loss of CC messages 326 for each of their corresponding RGWs 312 as was required in the prior art.

Note 1: If desired the IWF 324 and the proactive connectivity monitoring method 350 can be implemented in the bridge-on-line card 315 instead of the bridge-on-network-interface card 313. This alternate location of the IWF 324 may be used if one wanted to help alleviate the processing on the bridge-on-network-interface card 313.
Note 2: The present invention can be implemented as well in an access network that is based on a PON model in which case the DSLAM 310 would be replaced by both an OLT and an ONT. Typically, the OLT-ONT can be used in a FTTU architecture while the DSLAM would be used in a FTTN architecture.

From the foregoing, it can be seen that each DSLAM 310 effectively acts as a proxy to collect CC messages 326 received from their corresponding RGWs 312 and sends an alarm message 328 to the BNG 304 only when there is a loss of connectivity detected with any of their corresponding RGWs 312. Thus, there is a local termination of Ethernet CC messages 32 at the DSLAMs 310, combined with some protocol that indicates loss of connectivity to the BNG 304 such as an Ethernet AIS message 328, an ANCP/L2CP message 328, or a SNMP trap 328. This is a marked-improvement over the prior art in which all of the RGWs 312 would have had to send periodic CC messages 326 directly to the BNG 304 so that the BNG 304 could proactively monitor the connectivity to the corresponding RGWs 312. There are several other advantages associated with the present invention some of which are listed below:

1. The present invention described here applies not only to IPTV architectures but to other similar architectures.

2. The IWF 324 need not be standardized since it is implemented internal to the access node 310.

3. The connectivity monitoring method 350 is scalable, proactive, and relatively simple to implement in current access nodes 301.

4. The BNG 304 is aware of the loss of RGW 312 connectivity without the need to store state information nor the need to perform processing for each RGW 312. This significantly reduces memory and processing requirements on the BNG 304.

5. There is no need to change the IEEE CFM standard behaviors to implement the proactive connectivity monitoring method 350. However, there may be a need to standardize the message format between the access node 310 and the edge router 304 to enable the exchange of the alarm message 328. However, the Ethernet AIS message, an ANCP/L2CP message, or a SNMP trap are excellent candidates for the alarm message 328 because they provide the required semantics including the message type and the header plus the message layout has already been defined.

Although one embodiment of the present invention has been illustrated in the accompanying Drawings and described in the foregoing Detailed Description, it should be understood that the present invention is not limited to the disclosed embodiment, but is capable of numerous rearrangements, modifications and substitutions without departing from the spirit of the invention as set forth and defined by the following claims.

1. A method for proactively monitoring the connectivity of a plurality of end devices, said method comprising the steps of:
receiving continuity check messages from at least one of the plurality of end devices;
polling the received continuity check messages to ascertain the connectivity of each end device; and
if at least one continuity check message is detected as missing from one of the end devices during the polling step, then sending an alarm message indicating a loss of connectivity to the one end device.

2. The method of claim 1, wherein an access node performs the receiving step, the polling step and the sending step.

3. The method of claim 2, wherein said access node includes an interworking function which receives the continuity check messages on a first maintenance association, polls the received connectivity messages, and if necessary sends the alarm message on a second maintenance association.

4. The method of claim 2, wherein said access node includes:
a Digital Subscriber Line Access Multiplexer; or
an Optical Line Termination-Optical Network Termination.

5. The method of claim 1, wherein said polling step has a polling rate based on a total number of the end devices.

6. The method of claim 1, wherein the end devices are residential gateways.

7. The method of claim 1, wherein said alarm message is an Ethernet AIS message.

8. The method of claim 1, wherein said alarm message is an ANCP/L2CP message.

9. The method of claim 1, wherein said alarm message is a SNMP trap.

10. An access node, comprising:
a processor; and
a memory, where said processor retrieves instructions from said memory and processes those instructions to enable an interworking function to perform the following operations:
receive continuity check messages from at least one of a plurality of end devices;
poll the received continuity check messages to ascertain the connectivity of each end device; and
if at least one continuity check message is detected as missing from one of the end devices during the polling step, then sending an alarm message indicating a loss of connectivity to the one end device.

11. The access node of claim 10, further comprising a bridge-on-network-interface card that incorporates the interworking function wherein the interworking function receives the continuity check messages on a first maintenance association and if necessary sends the alarm message on a second maintenance association.

12. The access node of claim 10, further comprising a bridge-on-line card that incorporates the interworking function wherein the interworking function receives the continuity check messages on a first maintenance association and if necessary sends the alarm message on a second maintenance association.

13. The access node of claim 10, wherein said alarm message is an Ethernet AIS message.

14. The access node of claim 10, wherein said alarm message is an ANCP/L2CP message.

15. The access node of claim 10, wherein said alarm message is a SNMP trap.

16. A method for proactively monitoring a connectivity of a plurality of end devices within an access system which also includes an edge router and an access node, said method comprising the steps of:
receiving continuity check messages at the access node, where the continuity check messages are sent from at least one of the plurality of end devices;
polling the received continuity check messages at the access node to ascertain the connectivity of each end device; and
if at least one continuity check message is detected as missing from one of the end devices during the polling step, then sending an alarm message from the access node to the edge router, where the alarm message indicates a loss of connectivity to the one end device.

17. The method of claim 16, wherein:
said edge router is a broadband network gateway;
said access node is a Digital Subscriber Line Access Multiplexer or an Optical Line Termination-Optical Network Termination; and
said end devices are residential gateways.

18. The method of claim 16, wherein said alarm message is an Ethernet AIS message.

19. The method of claim 16, wherein said alarm message is an ANCP/L2CP message.

20. The method of claim 16, wherein said alarm message is a SNMP trap.
